(19) United States
(12) Patent Application Publication
(10) Pub. No.: US 2013/0268623 A1
(43) Pub. Date: Oct. 10, 2013

(54) METHODS AND APPARATUS TO MEASURE EXPOSURE TO STREAMING MEDIA

(71) Applicants: Jan Besehanic, Tampa, FL (US); Arun Ramaswamy, Tampa, FL (US)

(72) Inventors: Jan Besehanic, Tampa, FL (US); Arun Ramaswamy, Tampa, FL (US)

(21) Appl. No.: 13/793,991

(22) Filed: Mar. 11, 2013

Related U.S. Application Data
(63) Continuation of application No. 13/443,596, filed on Apr. 10, 2012.

(51) Int. Cl. H04L 29/06

(52) U.S. Cl. CPC H04L 65/607
USPC 709/217

(57) ABSTRACT

Methods and apparatus to measure exposure to streaming media are disclosed herein. An example method includes extracting metering data from media obtained from a media provider. Metadata identifying the media based on the extracted metering data is generated. The media is transcoded into a transport stream, the transport stream having a streaming format. The metadata is embedded in a metadata channel of the transport stream.

### RELATED APPLICATION

This patent arises from a continuation of U.S. patent application Ser. No. 13/443,596, which was filed on Apr. 10, 2012 and is hereby incorporated herein by reference in its entirety.

### FIELD OF THE DISCLOSURE

This disclosure relates generally to measuring media exposure, and, more particularly, to methods and apparatus to measure exposure to streaming media.

### BACKGROUND

Streaming enables media to be delivered to and presented by a wide variety of media presentation devices, such as desktop computers, laptop computers, tablet computers, personal digital assistants, smartphones, etc. A significant portion of media (e.g., content and/or advertisements) is presented via streaming to such devices.

### BRIEF DESCRIPTION OF THE DRAWINGS

FIG. 1 is a diagram of an example system for measuring exposure to streaming media.

FIG. 2 is a block diagram of an example implementation of the media monitor of FIG. 1.

FIG. 3 is example Hypertext Markup Language (HTML) code representing a webpage that may be displayed by the example media monitor of FIG. 2.

FIG. 4 is a flowchart representative of example machine-readable instructions which may be executed to implement the example service provider of FIG. 1

FIG. 5 is a flowchart representative of example machine-readable instructions which may be executed to implement the example media monitor of FIGS. 1 and/or 2.

FIG. 6 is a block diagram of an example implementation of an example HLS stream that may be displayed by the example media monitor of FIG. 2.

FIG. 7 is a block diagram of an example processor platform capable of executing the example machine-readable instructions of FIGS. 4 and/or 5 to implement the example service provider of FIG. 1 and/or the example media monitor of FIGS. 1 and/or 2.

### DETAILED DESCRIPTION

Example methods, apparatus, systems, and articles of manufacture disclosed herein may be used to measure exposure to streaming media. Some such example methods, apparatus, and/or articles of manufacture measure such exposure based on media metadata, user demographics, and/or media device types. Some examples disclosed herein may be used to monitor streaming media transmissions received at client devices such as personal computers, tablets (e.g., an iPad®), portable devices, mobile phones, Internet appliances, and/or any other device capable of playing media. Some example implementations disclosed herein may additionally or alternatively be used to monitor playback of locally stored media in media devices. Example monitoring processes disclosed herein collect media metadata associated with media presented via media devices and associate the metadata with demographics information of users of the media devices. In this manner, detailed exposure metrics are generated based on collected media metadata and associated user demographics.

The use of mobile devices (e.g., smartphones, tablets, MP3 players, etc.) to view media has increased in recent years. Initially, service providers created custom applications (e.g., apps) to display their media. As more types of mobile devices having different software requirements, versions, compatibilities, etc., entered the market, service providers began displaying streaming media in a browser of the mobile device. Consequently, many users view streaming media via the browser of their mobile device. Accordingly, understanding how users interact with the streaming media (e.g., such as by understanding what media is presented, how the media is presented, etc.) provides valuable information to service providers, advertisers, content providers, manufacturers, and/or other entities.

In some examples, metering data having a first format is extracted from media decoded from a transport stream. In some such examples, the transport stream corresponds to a Moving Picture Experts Group (MPEG) 2 transport stream sent according to a hypertext transfer protocol (HTTP) live streaming (HLS) protocol. The metering data having the first format can include an audio watermark that is embedded in an audio portion of the media. Additionally or alternatively, the metering data having the first format can include a video (e.g., image) watermark that is embedded in a video portion of the media. In some examples, the extracted metering data having the first format is transcoded into metering metadata having a second format. The metering data having the second format may correspond to, for example, metadata represented in a text format, such as a text format for inclusion in a streaming manifest file (e.g., an M3U file).

Some example methods disclosed herein to monitor streaming media include decoding a transport stream carrying media being streamed to a media presentation device to obtain the media. These example methods also include extracting metering data from the media and/or receiving metering data from an independent metering data source. The metering data identifies at least one of the media or a source of the media. Additionally, these example methods further include decoding media identifying metadata (e.g., such as electronic guide data, playlist data, etc.) already accompanying the transport stream carrying the media. These example methods further include verifying the media identifying metadata using the metering data extracted from the media.

In some disclosed examples, streaming media is delivered to the client device using HTTP Live Streaming (HLS). However, any other past, present, and/or future method of streaming media to the client device may additionally or alternatively be used such as, for example, an HTTP Secure (HTTPS) protocol. HLS transport streams allow metadata to be included in and/or associated with, for example, a media stream, a timed text track, etc. In some disclosed examples, a client device uses a browser to display media received via HLS. Additionally or alternatively, in some disclosed examples the client device uses a media presenter (e.g., a browser plugin, an app, a framework, an application programming interface (API), etc.) to display media received via HLS.

In examples illustrated below, media exposure metrics are monitored by retrieving metadata embedded in or otherwise transported with the media presented via a media presenter of the client device. In some examples, the metadata is stored in a Document Object Model (DOM) object. In some examples, the metadata is stored in an ID3 tag format, although any other past, present, and/or future metadata format may additionally or alternatively used. The DOM is a cross-platform and language-independent convention for representing and interacting with objects in Hypertext Markup Language (HTML). In some examples, media presenters (e.g., media plugins) such as, for example, the QuickTime player, emit DOM events that can be captured via JavaScript. By capturing the DOM events triggered by the media presenter, it is possible to extract the metadata (e.g., the ID3 tag data) via the DOM. Once extracted, the metadata may be combined with other information such as, for example, cookie data associated with the user of the device, and transmitted to, for example, a central facility for analysis and/or computation with data collected from other devices.

Example methods, apparatus, systems, and articles of manufacture disclosed herein involve extracting or collecting metadata (e.g., metadata stored in an ID3 tag, extensible markup language (XML) based metadata, and/or metadata in any other past, present, and/or future format) associated with streaming media transmissions (e.g., streaming audio and/or video) at a client device. In some examples, the metadata identifies one or more of a genre, an artist, a song title, an album name, a transmitting station/server site, etc. In such examples, highly granular (e.g., very detailed) data can be collected. Whereas in the past ratings were largely tied to specific programs or broadcasting stations, example methods, apparatus, systems, and/or articles of manufacture disclosed herein can generate ratings for a genre, an artist, a song, an album/CD, a particular transmitting/server site, etc. in addition to or as an alternative to generating ratings for specific programs, advertisements, content providers, broadcasters, and/or stations.

In some examples, metadata collection may be triggered based on media change events detected in media players (e.g., a media presentation event such as, for example, a start event, a stop event, a skip event, etc.). A media change event typically causes a change in information identified by the extracted metadata (e.g., a change in genre, a change in artist, a change in title, etc.) and, thus, can be a useful trigger for data collection. In some examples, media change events are detected while the media is being played (e.g., a newly displayed video frame may be considered a media change event). In some other examples, media change events are detected when there is a change associated with a timed text track of the streaming media. Timed text tracks may be used to, for example, cause display of text (e.g., closed captioning, comments, metadata, etc.) associated with the streaming media. In any of the above examples, the collected metadata may be time stamped based on its time of collection.

Example methods, apparatus, systems, and articles of manufacture disclosed herein collect demographic information associated with users of client devices based on identifiers (e.g., an Internet protocol (IP) address, a cookie, a device identifier, etc.) associated with those client devices. Media exposure information may then be generated based on the media metadata and the user demographics to indicate exposure metrics and/or demographic reach metrics for at least one of a genre, an artist, an album name, a transmitting station/server site, etc.

In some instances, it is important to link demographics to the monitoring information. To address this issue, the audience measurement entity establishes a panel of users who have agreed to provide their demographic information and to have their streaming media activities monitored. When an individual joins the panel, they provide detailed information concerning their identity and demographics (e.g., gender, race, income, home location, occupation, etc.) to the audience measurement entity. The audience measurement entity sets a cookie (e.g., a panelist cookie) on the presentation device that enables the audience measurement entity to identify the panelist whenever the panelist accesses streamed media.

Example methods, apparatus, systems, and articles of manufacture disclosed herein may also be used to generate reports indicative of media exposure metrics on one or more different types of client devices (e.g., personal computers, portable devices, mobile phones, tablets, etc.). For example, a media audience measurement entity may generate media exposure metrics based on metadata extracted from the streaming media at the client device and/or similar devices. A report is then generated based on the media exposure to indicate exposure measurements for a type of media (e.g., a genre) using different types of client devices. Thus, for example, reports indicating the popularity of watching, for instance, sports events on certain client devices (e.g., mobile devices, tablets, etc.) can be compared to other popularities of watching sports events on other client devices (e.g., televisions, personal computers, etc.).

Additionally or alternatively, popularities of different types of media across different device types may be compared. Such different types of media may be, for example, news, movies, television programming, on-demand media, Internet-based media, games, streaming games, etc. Such comparisons may be made across any type(s) and/or numbers of devices including, for example, cell phones, smart phones, dedicated portable multimedia playback devices, iPod® devices, tablet computing devices, iPad® devices, standard-definition (SD) televisions, high-definition (HD) televisions, three-dimensional (3D) televisions, stationary computers, portable computers, Internet radios, etc. Any other type(s) and/or number of media and/or devices may be analyzed. The report may also associate the media exposure metrics with demographic segments (e.g., age groups, genders, etc.) corresponding to the user(s) of the client device(s). Additionally or alternatively, the report may associate the media exposure metrics with metric indicators of popularity of artist, genre, song, title, etc., across one or more user characteristics selected from one or more demographic segment(s), one or more age group(s), one or more gender(s), and/or any other user characteristic(s).

In some examples, the media exposure metrics are used to determine demographic reach of streaming media, ratings for streaming media, engagement indices for streaming media, user affinities associated with streaming media, and/or any other audience measure metric associated with streaming media and/or locally stored media. In some examples, the media exposure metrics are audience share metrics indicative of percentages of audiences for different device types that accessed the same media. For example, a first percentage of an audience may be exposed to news media via smart phones, while a second percentage of the audience may be exposed to the same news media via tablets.

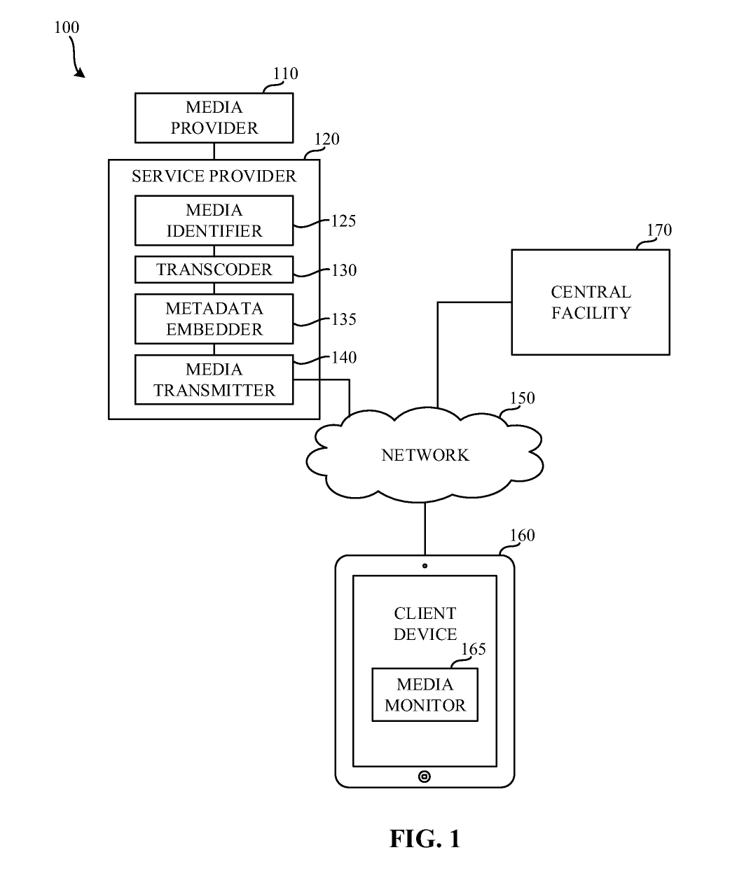

FIG. 1 is a diagram of an example system 100 constructed in accordance with the teachings of this disclosure for measuring exposure to streaming media. The example system 100 of FIG. 1 monitors media provided by an example media provider 110 for presentation on an example client device 160 via an example network 150. The example system 100 includes an example service provider 120, an example media monitor 165, and an example central facility 170 of an audience measurement entity. While the illustrated example of FIG. 1 discloses an example implementation of the service provider 120, other example implementations of the service provider 120 may additionally or alternatively be used, such as the example implementations disclosed in co-pending U.S. patent application Ser. No. 13/341,646, which is hereby incorporated by reference herein in its entirety.

The media provider 110 of the illustrated example of FIG. 1 corresponds to any one or more media provider(s) capable of providing media for presentation at the client device 160. The media provided by the media provider(s) 110 can be any type of media, such as audio, video, multimedia, etc. Additionally, the media can correspond to live (e.g., broadcast) media, stored media (e.g., on-demand content), etc.

The service provider 120 of the illustrated example of FIG. 1 provides media services to the client device 160 via, for example, web pages including links (e.g., hyperlinks, embedded media, etc.) to media provided by the media provider 110. In the illustrated example, the service provider 120 modifies the media provided by the media provider 110 prior to transmitting the media to the client device 160. In the illustrated example, the service provider 120 includes an example media identifier 125, an example transcoder 130, an example metadata embedder 135, and an example media transmitter 140.

The media identifier 125 of the illustrated example of FIG. 1 is implemented by a logic circuit such as a processor executing instructions, but it could additionally or alternatively be implemented by an application specific integrated circuit(s) (ASIC(s)), programmable logic device(s) (PLD(s)) and/or field programmable logic device(s) (FPLD(s)), an analog circuit, and/or other circuitry. The media identifier 125 of FIG. 1 extracts metering data (e.g., signatures, watermarks, etc.) from the media obtained from the media provider 110. For example, the media identifier 125 can implement functionality provided by a software development kit (SDK) to extract one or more audio watermarks, one or more video (e.g., image) watermarks, etc., embedded in the audio and/or video of the media obtained from the media provider 110. (For example, the media may include pulse code modulation (PCM) audio data or other types of audio data, uncompressed video/image data, etc.)

The example media identifier 125 of FIG. 1 determines (e.g., derives, decodes, converts, etc.) the metering data (e.g., such as media identifying information, source identifying information, etc.) included in or identified by a watermark embedded in the media and converts this metering data and/or the watermark itself into a text and/or binary format for inclusion in an ID3 tag and/or other data type (e.g., text, binary, etc.) for transmission as metadata (e.g., such as with a playlist or electronic program guide) accompanying the streaming media. For example, the code/watermark itself may be extracted and inserted as metadata in, for example, a text or binary format in the ID3 tag. Thus, the metadata and/or media-identifying metadata included in the ID3 tag may be a text or binary representation of a code, a watermark, and/or metadata or data identified by a code and/or watermark, etc.

The example transcoder 130 of the illustrated example of FIG. 1 is implemented by a logic circuit such as a processor executing instructions, but could additionally or alternatively be implemented by an analog circuit, ASIC, DSP, FPGA, and/or other circuitry. In some examples, the transcoder 130 and the media identifier 125 are implemented by the same physical processor. In the illustrated example, the transcoder 130 employs any appropriate technique(s) to transcode and/or otherwise process the received media into a form suitable for streaming (e.g., a streaming format). For example, the transcoder 130 of the illustrated example transcodes the media in accordance with MPEG 4 audio/video compression for use via the HLS protocol.

The metadata embedder 135 of the illustrated example of FIG. 1 is implemented by a logic circuit such as a processor executing instructions, but could additionally and/or alternatively be implemented by an analog circuit, ASIC, DSP, FPGA, and/or other circuitry. In some examples, the transcoder 130, the media identifier 125, and the metadata embedder 135 are implemented by the same physical processor.

In the illustrated example, the metadata embedder 135 embeds the metadata determined by the media identifier 125 into the transport stream(s) carrying the streaming media. In the illustrated example, the metadata embedder 135 embeds the metadata into an internal metadata channel, such as by encoding metadata that is in a binary and/or other appropriate data format into one or more data fields of the transport stream(s) that is(are) capable of carrying metadata. For example, the metadata embedder 135 can insert ID3 tag metadata corresponding to the metering metadata into the transport stream(s) that is (are) to stream the media in accordance with the HLS or other appropriate streaming protocol. Additionally or alternatively, the metadata embedder 135 may embed the metadata into an external metadata channel, such as by encoding the metadata into an M3U8 or other data file that is to be associated with (e.g., included in, appended to, sent prior to, etc.) the transport stream(s) that are to provide the streaming media to the client device 160.

The media transmitter 140 of the illustrated example of FIG. 1 is implemented by a logic circuit such as a processor executing instructions, but could additionally or alternatively be implemented by an analog circuit, ASIC, DSP, FPGA, and/or other circuitry. In some examples, the transcoder 130, the media identifier 125, the metadata embedder 135, and the media transmitter 140 are implemented by the same physical processor.

The media transmitter 140 employs any appropriate technique(s) to select and/or stream the media to a requesting device, such as the client device 160. For example, the media transmitter 140 of the illustrated example selects media that has been identified by the media identifier 125, transcoded by the transcoder 130 and undergone metadata embedding by the metadata embedder 135. The media transmitter 140 then streams the media to the client device 160 via the network 150 using HLS or any other streaming protocol.

In some examples, the media identifier 125, the transcoder 130, and/or the metadata embedder 130 prepare media for streaming regardless of whether (e.g., prior to) a request is received from the client device 160. In such examples, the already-prepared media is stored in a data store of the service provider 120 (e.g., such as in a flash memory, magnetic media, optical media, etc.). In such examples, the media transmitter 140 prepares a transport stream for streaming the already-prepared media to the client device 160 when a request is received from the client device 160. In other examples, the media identifier 125, the transcoder 130, and/or the metadata embedder 130 prepare the media for streaming in response to a request received from the client device 160.

The example network 150 of the illustrated example is the Internet. Additionally or alternatively, any other network(s) communicatively linking the service provider 120 and the client device such as, for example, a private network, a local area network (LAN), a virtual private network (VPN), etc. may be used. The network 150 may comprise any number of public and/or private networks using any type(s) of networking protocol(s).

The client device 160 of the illustrated example of FIG. 1 is a computing device that is capable of presenting streaming media provided by the media transmitter 140 via the network 150. The client device 160 may be, for example, a tablet, a desktop computer, a laptop computer, a mobile computing device, a television, a smart phone, a mobile phone, an Apple® iPad®, an Apple® iPhone®, an Apple® iPod®, an Android™ powered computing device, a Palm® webOS® computing device, etc. In the illustrated example, the client device 160 includes a media monitor 165. In the illustrated example, the media monitor 165 is implemented by a media player (e.g., a browser, a local application, etc.) that presents streaming media provided by the media transmitter 140. For example, the media monitor 165 may additionally or alternatively be implemented in Adobe® Flash® (e.g., provided in a SWF file), may be implemented in hypertext markup language (HTML) version 5 (HTML5), may be implemented in Google® Chromium®, may be implemented according to the Open Source Media Framework (OSMF), may be implemented according to a device or operating system provider's media player application programming interface (API), may be implemented on a device or operating system provider's media player framework (e.g., the Apple® iOS® MPMoviePlayer software), etc., or any combination thereof. In the illustrated example, the media monitor 165 reports metering data to the central facility 170. While a single client device 160 is illustrated, any number and/or type(s) of media presentation devices may be used.

The central facility 170 of the audience measurement entity of the illustrated example of FIG. 1 includes an interface to receive reported metering information (e.g., metadata) from the media monitor 165 of the client device 160 via the network 150. In the illustrated example, the central facility 170 includes an HTTP interface to receive HTTP requests that include the metering information. Additionally or alternatively, any other method(s) to receive metering information may be used such as, for example, an HTTP Secure protocol (HTTPS), a file transfer protocol (FTP), a secure file transfer protocol (SFTP), etc. In the illustrated example, the central facility 170 stores and analyzes metering information received from a plurality of different client devices. For example, the central facility 170 may sort and/or group metering information by media provider 110 (e.g., by grouping all metering data associated with a particular media provider 110). Any other processing of metering information may additionally or alternatively be performed.

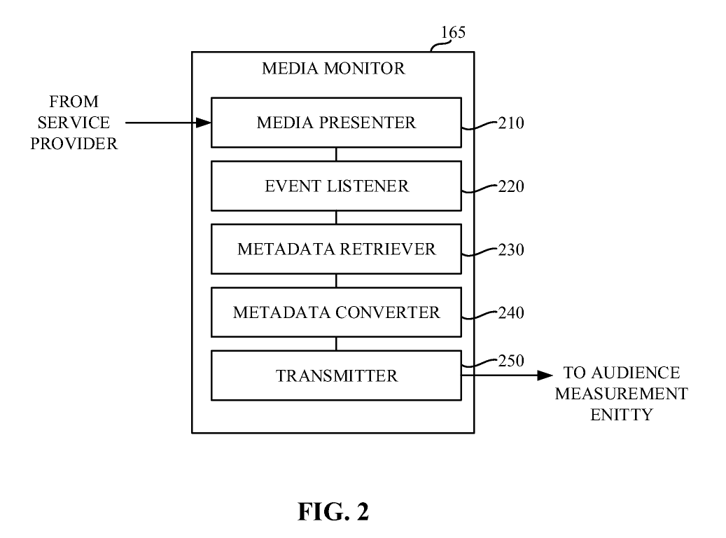

FIG. 2 is a block diagram of an example implementation of the media monitor 165 of FIG. 1. The media monitor 165 of the illustrated example of FIG. 2 includes an example media presenter 210, an example event listener 220, an example metadata retriever 230, an example metadata converter 240, and an example transmitter 250.

The media presenter 210 of the illustrated example of FIG. 2 is implemented by a processor executing instructions, but it could additionally or alternatively be implemented by an analog circuit, an ASIC, DSP, FPGA, and/or other circuitry. In the illustrated example, the media presenter 210 interacts with a QuickTime® application programming interface (API) to display media via the client device 160. While in the illustrated example, the QuickTime® API is used, any other media presenting framework may additionally or alternatively be employed. For example, the example media presenter 210 may interact with an Adobe® Flash® media presentation framework.

The example event listener 220 of the illustrated example of FIG. 2 is implemented by a logic circuit such as a processor executing instructions, but it could additionally or alternatively be implemented by an analog circuit, an ASIC, DSP, FPGA, and/or other circuitry. In some examples, the media presenter 210 and the event listener 220 are implemented by the same physical processor. In the illustrated example, the example event listener 220 interfaces with JavaScript functions to enable reception of and/or listening for an event notification. While JavaScript is used to listen for event notifications in the illustrated example, any other framework, such as, for example, ActiveX, Microsoft Silverlight, etc., may be used to listen for event notifications.

The metadata retriever 230 of the illustrated example of FIG. 2 is implemented by a logic circuit such as a processor executing instructions, but it could additionally or alternatively be implemented by an analog circuit, an ASIC, DSP, FPGA, and/or other circuitry. In some examples, the media presenter 210, the event listener 220, and the metadata retriever 230 are implemented by the same physical processor. In the illustrated example, the metadata retriever 230 retrieves metadata from the media presenter 210 upon detection of an event notification by the event listener 220. In the illustrated example, the metadata retriever 230 retrieves the metadata by inspecting a document object model (DOM) object of the media presenter 210 using JavaScript. While JavaScript is used to retrieve the DOM object in the illustrated example, any other framework, such as, for example, ActiveX, Microsoft Silverlight, etc., may be used to retrieve the DOM object.

The metadata converter 240 of the illustrated example of FIG. 2 is implemented by a logic circuit such as a processor executing instructions, but it could additionally or alternatively be implemented by an analog circuit, an ASIC, DSP, FPGA, and/or other circuitry. In some examples, the media presenter 210, the event listener 220, the metadata retriever 230, and the metadata converter 240 are implemented by the same physical processor. In the illustrated example, the metadata converter 240 converts the metadata retrieved by the metadata retriever 230 into a format for transmission to the central facility 170. For example, the metadata converter 240 may encrypt, decrypt, compress, modify, etc., the metadata and/or portions of the metadata to, for example, reduce the amount of data to be transmitted to the central facility 170.

The transmitter 250 of the illustrated example of FIG. 2 is implemented by a logic circuit such as a processor executing instructions, but it could additionally or alternatively be implemented by an analog circuit, an ASIC, DSP, FPGA, and/or other circuitry. In some examples, the media presenter 210, the event listener 220, the metadata retriever 230, the metadata converter 240, and the transmitter 250 are implemented by the same physical processor. In the illustrated example, the transmitter 250 transmits the converted metadata to the central facility 170 via, for example, the Internet. While the metadata is transmitted in substantially real-time in the illustrated example, in some examples, the metadata is stored, cached, and/or buffered before being transmitted to the central facility 170. Also, while the metadata is additionally or alternatively transmitted to the central facility 170 in the illustrated example, in some examples, the metadata is transmitted to a different destination such as, for example, a display element of the media monitor 165 and/or the client device 160. Additionally or alternatively, the transmitter 250 may transmit an identifier of the media monitor 165 and/or the client device 160 to enable the central facility 170 to correlate the metadata with a panelist, a group of panelists, a demographic, etc. In the illustrated example the central facility is associated with an audience measurement company and is not involved with the delivery of media to the client device.

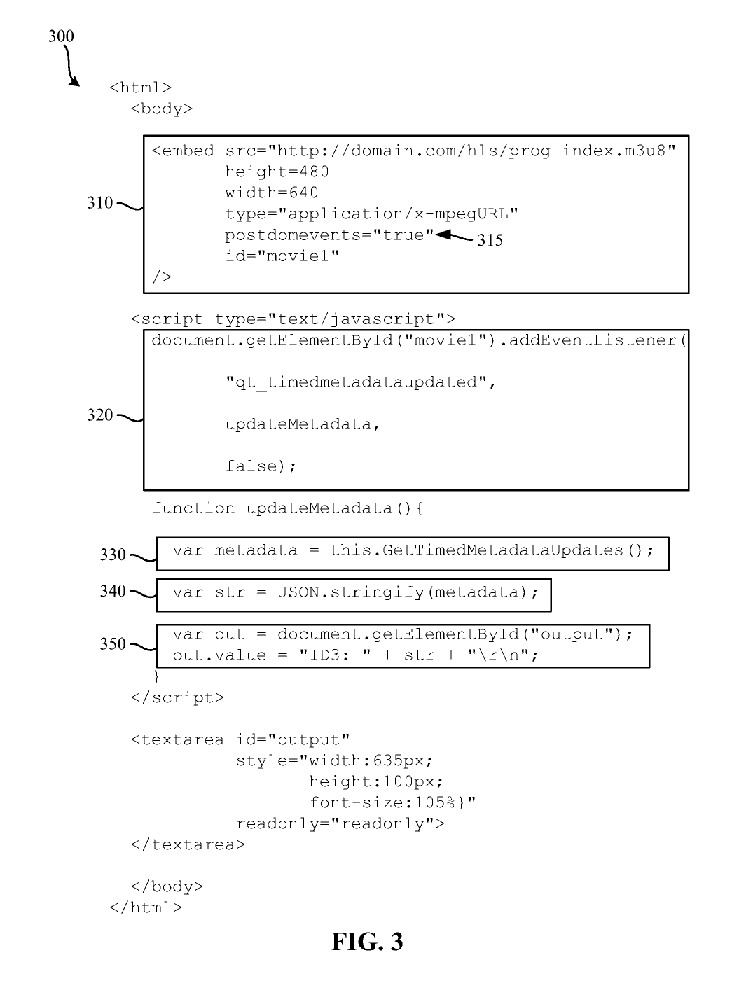

FIG. 3 illustrates example Hypertext Markup Language (HTML) instructions 300 representing a webpage that may be displayed by the media monitor 165 of FIG. 2 when included in the client device 160 of FIG. 1. In the illustrated example, an example embed tag 310 instantiates the media presenter 210. In the illustrated example, the media presenter 210 is instantiated with a media source having a universal resource indicator (URI), a frame having a given height and width, a display type of application/s-mpegURL, an instruction to post DOM events 315, and an identifier. In the illustrated example, the instruction to post DOM events 315 is included because, in the illustrated example, the media presenter 210 (e.g., QuickTime®, etc.) requires this option to be set in order to enable posting of DOM events. However, in some examples, the media presenter 210 may post DOM events without such an option being set.

An example add event listener function 320 included in the HTML code 300 instantiates the event listener 220 of FIG. 2. In the illustrated example, the event listener 220 is instantiated by specifying the intended element (e.g., the element identified as being instantiated with the media presenter 210), specifying an event type (e.g., “qt timedmetadataupdated”, etc.), and specifying that the function updateMetadata should be executed when the event is detected. In the illustrated example, the event type that is detected is “qt_timedmetadataupdated”, which is an event that is triggered by the media presenter 210. However, any other type of event may additionally or alternatively used, such as, for example, an event type associated with a different media presenter, an event type associated with a different trigger of the media presenter 210, an event type associated with a different program than QuickTime® (“QT”), etc.

An example GetTimedMetadataUpdates function 330 included in the example HTML code 300 of FIG. 3 retrieves metadata associated with the object instantiated by the media presenter 210. In the illustrated example, the metadata is retrieved from the “movie1” object. In the illustrated example, the retrieved metadata is stored (e.g., cached, buffered, etc.) in a local variable “metadata”. In the illustrated example, the GetTimedMetadataUpdates function is specific to the media presenter 210 (e.g., QuickTime). Additionally or alternatively, any other function may be used to retrieve metadata from the object instantiated by the media presenter 210.

An example stringify function 340 included in the example HTML code 300 of FIG. 3 converts the retrieved metadata to a format for use by the transmitter 250. In the illustrated example, the retrieved metadata is in JavaScript Object Notation (JSON). When an object is stored in JSON, it is stored as a hash value. In the illustrated example, the stringify function 340 converts the metadata stored in JSON into human readable metadata that represents an ID3 tag. In the illustrated example, the human readable metadata is stored (e.g., cached, buffered, etc.) in a local variable “str”.

In the illustrated example, block 350 of the example HTML code 300 of FIG. 3 transmits the converted metadata to a text area (defined in the illustrated example as “output”). In some examples, block 350 is modified to additionally or alternatively transmit the converted metadata to the central facility 170. In some examples, the metadata is transmitted in JSON format (block 350). In some examples, block 350 transmits other information such as, for example, user identifying information, client information, etc., in addition or as an alternative to the metadata.

While example manners of implementing the service provider 120 of FIG. 1 and/or the example media monitor 165 of FIGS. 1 and/or 2 have been illustrated in FIGS. 1 and/or 2, one or more of the elements, processes and/or devices illustrated in FIGS. 1 and/or 2 may be combined, divided, re-arranged, omitted, eliminated and/or implemented in any other way. Further, the example media identifier 125, the example transcoder 130, the example metadata embedder 135, the example media transmitter 140, and/or, more generally, the example service provider 120 of FIG. 1, and/or the example media presenter 210, the example event listener 220, the example metadata retriever 230, the example metadata converter 240, the example transmitter 250, and/or, more generally, the example media monitor 165 of FIGS. 1 and/or 2 may be implemented by hardware, software, firmware and/or any combination of hardware, software and/or firmware. Thus, for example, any of the example media identifier 125, the example transcoder 130, the example metadata embedder 135, the example media transmitter 140, and/or, more generally, the example service provider 120 of FIG. 1, and/or the example media presenter 210, the example event listener 220, the example metadata retriever 230, the example metadata converter 240, the example transmitter 250, and/or, more generally, the example media monitor 165 of FIGS. 1 and/or 2 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example media identifier 125, the example transcoder 130, the example metadata embedder 135, the example media transmitter 140, the example media presenter 210, the example event listener 220, the example metadata retriever 230, the example metadata converter 240, and/or the example transmitter 250 are hereby expressly defined to include a tangible computer readable medium such as a memory, DVD, CD, Blu-ray, etc. storing the software and/or firmware. Further still, the example media identifier 125, the example transcoder 130, the example metadata embedder 135, the example media transmitter 140, and/or, more generally, the example service provider 120 of FIG. 1, and/or the example media presenter 210, the example event listener 220, the example metadata retriever 230, the example metadata converter 240, the example transmitter 250, and/or, more generally, the example media monitor 165 of FIGS. 1 and/or 2 may include one or more elements, processes and/or devices in addition to, or instead of, those illustrated in FIGS. 1 and/or 2, and/or may include more than one of any or all of the illustrated elements, processes and devices.

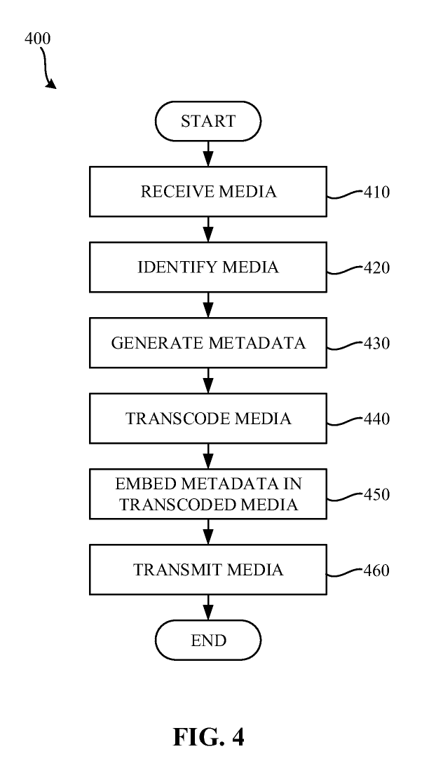

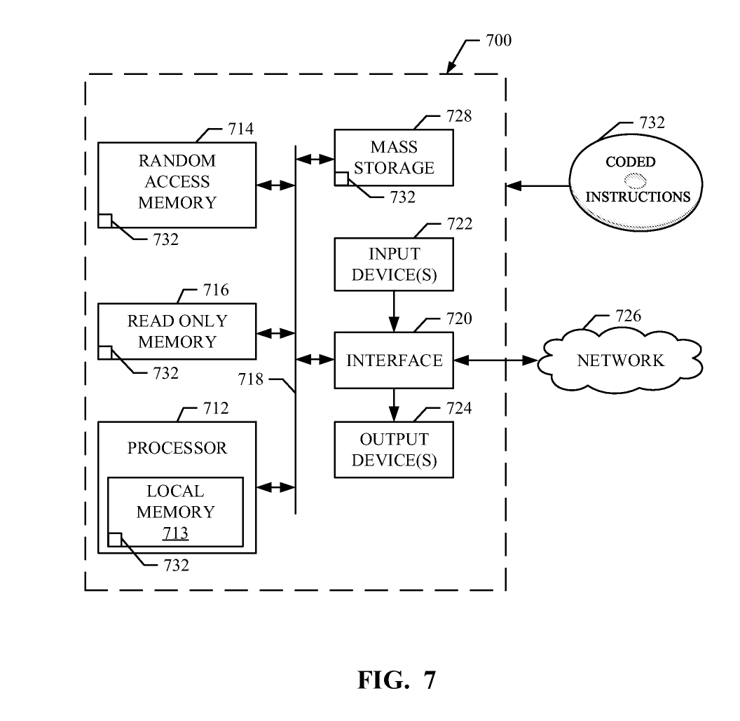

Flowcharts representative of example machine-readable instructions for implementing the service provider 120 of FIG. 1 and/or the media monitor 165 of FIGS. 1 and/or 2 are shown in FIGS. 4 and/or 5. In these examples, the machine-readable instructions comprise a program for execution by a logic circuit such as the processor 712 shown in the example processor platform 700 discussed below in connection with FIG. 7. The program(s) may be embodied in software stored on a tangible computer-readable medium such as a CD-ROM, a floppy disk, a hard drive, a digital versatile disk (DVD), a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowcharts illustrated in FIGS. 4 and/or 5, many other methods of implementing the example the example service provider 120 of FIG. 1 and/or the example media monitor 165 of FIGS. 1 and/or 2 may alternatively be used. For example, the order of execution of the blocks may be changed, and/or some of the blocks described may be changed, eliminated, or combined.

As mentioned above, the example processes of FIGS. 4 and/or 5 may be implemented using coded instructions (e.g., computer-readable instructions) stored on a tangible computer-readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer-readable medium is expressly defined to include any type of computer-readable storage and to exclude propagating signals. Additionally or alternatively, the example processes of FIGS. 4 and/or 5 may be implemented using coded instructions (e.g., computer-readable instructions) stored on a non-transitory computer-readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer-readable medium is expressly defined to include any type of computer-readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 4 is a flowchart representative of example machine-readable instructions 400 which may be executed to implement the example service provider 120 of FIG. 1. Execution of the example machine-readable instructions 400 of FIG. 4 begins with the media identifier 125 of the service provider 120 receiving the media from the media provider 110 (block 410). In the illustrated example, the media is received as it is broadcast (e.g., live). However, in some examples, the media is stored and/or cached by the media identifier 125.

The media identifier 125 of the illustrated example then identifies the media (block 420). The media identifier 125 identifies the media by extracting metering data (e.g., signatures, watermarks, etc.) from the media. Based on the extracted metering data, the media identifier 125 generates metadata (block 430). In the illustrated example, the metadata is generated in an ID3 format. However, any other metadata format may additionally or alternatively be used. Further, in the illustrated example, the metadata is generated based on the extracted metering data. However, in some examples, the metadata may be generated by querying an external source using some or all of the extracted metering data.

The media is then transcoded by the transcoder 130 of the service provider 120 (block 440). In the illustrated example, the media is transcoded into an MPEG2 transport stream that may be transmitted via HTTP live streaming (HLS). The metadata embedder 135 of the service provider 120 embeds the metadata into the media (block 450). In the illustrated example, the metadata is embedded into a metadata channel of the media. However, in some examples, the metadata may be embedded in an ancillary data document, file, etc. that may be associated with the media. For example, the metadata may be embedded in a manifest file (e.g., an M3U8 file), in a text track associated with the media, etc.

The media is then transmitted by the media transmitter 140 of the service provider 120 (block 460). In the illustrated example, the media is transmitted using HTTP live streaming (HLS). However, any other format and/or protocol for transmitting (e.g., broadcasting, unicasting, multicasting, etc.) media may additionally or alternatively be used.

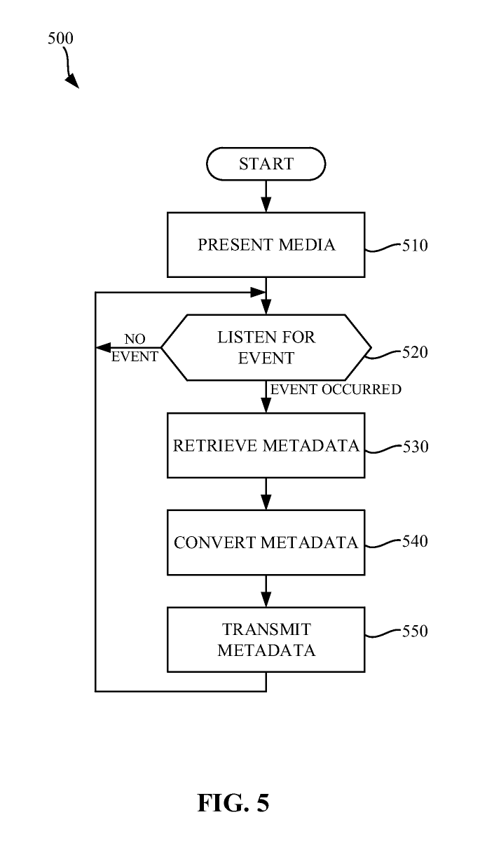

FIG. 5 is a flowchart representative of example machine-readable instructions 500 which may be executed to implement the example media monitor 165 of FIGS. 1 and/or 2. Execution of the example machine-readable instructions 500 of FIG. 5 begins with the media monitor 165 being instantiated (e.g., by being loaded by the client device 160). The media presenter 210 of the media monitor 165 then begins presenting media (block 510) by, for example, loading a display object for presentation via the client device 160. In the illustrated example, the display object is a QuickTime® object. However, any other type of display object may additionally or alternatively be used.

The event listener 220 of the media monitor 165 begins listening for an event (block 520). In the illustrated example, the event listener 220 listens for a JavaScript event triggered by the media presenter 210. However, in some examples, the event listener 220 listens for any other event(s) such as, for example, a media change event, a user interaction event (e.g., when a user clicks on an object), a display event (e.g., a page load), etc. If the event listener 220 does not detect an event, the event listener 220 continues to listen for the event until the media monitor 165 is closed.

If the event listener 220 detects an event, the metadata retriever 230 of the media monitor 165 retrieves the metadata (block 530). In the illustrated example, the event listener 220 passes an event object to the metadata retriever 230, which inspects the event object to retrieve the metadata. However, in some examples, the event listener 220 passes an identifier of an object (e.g., the media presenter 210 display object), which indicates the object from which the metadata retriever 230 is to retrieve metadata. In the illustrated example, the metadata retriever 230 inspects a document object module (DOM) object to retrieve the metadata. In the illustrated example, the metadata is formatted as an ID3 tag. However, any other format of metadata may additionally or alternatively be used.

The metadata converter 240 of the media monitor 165 then converts the metadata (block 540) into a format for use by the transmitter 250 of the media monitor 165. In the illustrated example, the metadata is converted from a binary data format into a text format. In some examples, the metadata is parsed to identify portions (e.g., fields, sections, etc.) of interest of the metadata (e.g., a genre, an artist, a song title, an album name, a transmitting station/server site, etc.). In some examples, the metadata converter 240 embeds an identifier of the presentation device and/or a user of the presentation device in the metadata. Including the identifier of the presentation device and/or the user of the presentation device enables the central facility 170 to correlate the media that was presented with the presentation device and/or the user(s) of the presentation device. In the illustrated example, the metadata converter 240 adds a timestamp to the metadata prior to transmitting the metadata to the central facility 170. Timestamping (e.g., recording a time that an event occurred) enables accurate identification and/or correlation of media that was presented and/or the time that it was presented with the user(s) of the presentation device.

In some examples, the metadata may not undergo conversion before transmission by the transmitter (e.g., the metadata may be sent in the format in which it is retrieved by the metadata retriever 230). In such examples, the central facility 170 converts the metadata into a format for use by the central facility 170 by, for example, converting the metadata to a different format, parsing the metadata to identify portions of interest of the metadata, etc. Conversion of the metadata by the central facility 170 facilitates correlation of the media that was presented with an identifier identifying to whom the media was presented. In some examples, the central facility 170 timestamps the metadata upon receipt. Timestamping the metadata enables accurate identification and/or correlation of media that was presented and/or the time that it was presented with the user(s) of the presentation device.

The transmitter 250 then transmits the metadata to the central facility 170 (block 550). In the illustrated example, the metadata is transmitted using an HTTP Post request. However, any other method of transmitting data and/or metadata may additionally or alternatively be used. For example, a file transfer protocol (FTP), an HTTP Get request, Asynchronous JavaScript and extensible markup language (XML) (AJAX), etc., may be used to transmit the metadata. In some examples, the metadata is not transmitted to the central facility 170. For example, the metadata may be transmitted to a display object of the client device 160 for display to a user. In the illustrated example, the metadata is transmitted in real-time (e.g., streamed) to the central facility 170. However, in some examples, the metadata may be stored (e.g., cached, buffered, etc.) for a period of time before being transmitted to the central facility 170.

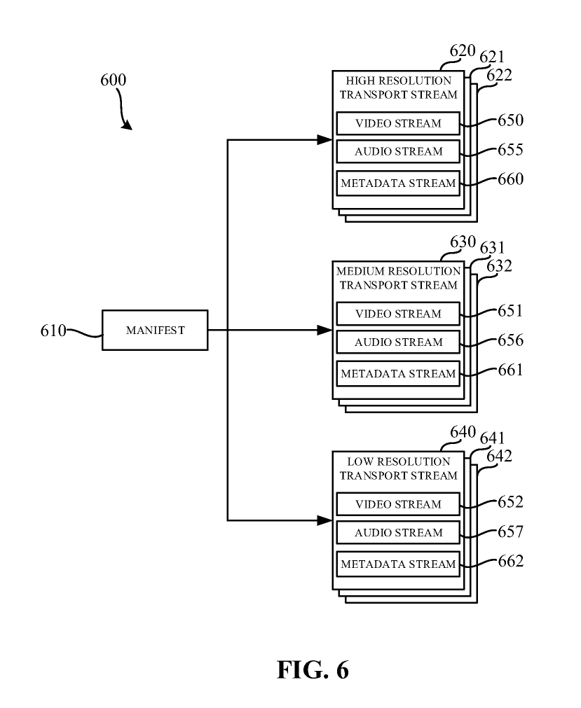

FIG. 6 is a block diagram of an example implementation of an example HLS stream 600 that may be displayed by the example media monitor of FIG. 2. In the illustrated example of FIG. 6, the HLS stream 600 includes a manifest 610 and three transport streams. In the illustrated example, the manifest 610 is an .m3u8 file that describes the available transport streams to the client device. However, any other past, present, and/or future file format may additionally or alternatively be used. In the illustrated example, the client device retrieves the manifest 610 in response to an instruction to display an HLS element. For example, block 310 of FIG. 1 includes an instruction that the client device should present the HLS element identified by the manifest 610 stored at “prog_index.m3u8”.

HLS is an adaptive format, in that, although multiple devices retrieve the same manifest 610, different transport streams may be displayed depending on one or more factors. For example, devices having different bandwidth availabilities (e.g., a high speed Internet connection, a low speed Internet connection, etc.) and/or different display abilities (e.g., a small size screen such as a cellular phone, a medium size screen such as a tablet and/or a laptop computer, a large size screen such as a television, etc.) select an appropriate transport stream for their display and/or bandwidth abilities. In some examples, a cellular phone having a small screen and limited bandwidth uses a low resolution transport stream. Alternatively, in some examples, a television having a large screen and a high speed Internet connection uses a high resolution transport stream. As the abilities of the device change (e.g., the device moves from a high speed Internet connection to a low speed Internet connection) the device may switch to a different transport stream.

In the illustrated example of FIG. 6, a high resolution transport stream 620, a medium resolution transport stream 630, and a low resolution transport stream 640 are shown. In the illustrated example, each transport stream 620, 630, and/or 640 represents a portion of the associated media (e.g., five seconds, ten seconds, thirty seconds, one minute, etc.). Accordingly, the high resolution transport stream 620 corresponds to a first portion of the media, a second high resolution transport stream 621 corresponds to a second portion of the media, a third high resolution transport stream 622 corresponds to a third portion of the media. Likewise, the medium resolution transport stream 630 corresponds to the first portion of the media, a second medium resolution transport stream 631 corresponds to the second portion of the media, and a third medium resolution transport stream 632 corresponds to the third portion of the media. In addition, the low resolution transport stream 640 corresponds to the first portion of the media, a second low resolution transport stream 641 corresponds to the second portion of the media, and a third low resolution transport stream 642 corresponds to the third portion of the media. Although three transport streams are shown in the illustrated example of FIG. 6 for each resolution, any number of transport streams representing any number of corresponding portions of the media may additionally or alternatively be used.

In the illustrated example, each transport stream 620, 621, 622, 630, 631, 632, 640, 641, and/or 642 includes a video stream 650, 651, 652, an audio stream 655, 656, 652, and a metadata stream 660, 661, 662. The video stream 650, 651, and/or 652 includes video associated with the media at different resolutions according to the resolution of the transport stream with which the video stream is associated. The audio stream 655, 656, and/or 657 includes audio associated with the media. The metadata stream 660, 661, and/or 662 includes metadata such as, for example, an ID3 tag associated with the media.

FIG. 7 is a block diagram of an example processor platform 700 capable of executing the example machine-readable instructions of FIGS. 4 and/or 5 to implement the example service provider 120 of FIG. 1 and/or the example media monitor 165 of FIGS. 1 and/or 2. The example processor platform 700 can be, for example, a server, a personal computer, a mobile phone (e.g., a cell phone), a tablet, a personal digital assistant (PDA), an Internet appliance, a DVD player, a CD player, a digital video recorder, a Blu-ray player, a gaming console, a personal video recorder, a set top box, or any other type of computing device.

The system 700 of the instant example includes a processor 712. For example, the processor 712 can be implemented by one or more microprocessors or controllers from any desired family or manufacturer.

The processor 712 includes a local memory 713 (e.g., a cache) and is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The computer 700 also includes an interface circuit 720. The interface circuit 720 may be implemented by any type of interface standard, such as an Ethernet interface, a universal serial bus (USB), and/or a PCI express interface.

One or more input devices 722 are connected to the interface circuit 720. The input device(s) 722 permit a user to enter data and commands into the processor 712. The input device(s) can be implemented by, for example, a keyboard, a mouse, a touchscreen, a track-pad, a trackball, isopoint and/or a voice recognition system.

One or more output devices 724 are also connected to the interface circuit 720. The output devices 724 can be implemented, for example, by display devices (e.g., a liquid crystal display, a cathode ray tube display (CRT), a printer and/or speakers). The interface circuit 720, thus, typically includes a graphics driver card.

The interface circuit 720 also includes a communication device (e.g., the media transmitter 140, the transmitter 250) such as a modem or network interface card to facilitate exchange of data with external computers via a network 726 (e.g., an Ethernet connection, a digital subscriber line (DSL), a telephone line, coaxial cable, a cellular telephone system, etc.).

The computer 700 also includes one or more mass storage devices 728 for storing software and data. Examples of such mass storage devices 728 include floppy disk drives, hard drive disks, compact disk drives, and digital versatile disk (DVD) drives.

The coded instructions 732 of FIGS. 4 and/or 5 may be stored in the mass storage device 728, in the volatile memory 714, in the non-volatile memory 716, in the local memory 713, and/or on a removable storage medium such as a CD or DVD.

Although certain example methods, apparatus, and articles of manufacture have been described herein, the scope of coverage of this patent is not limited thereto. On the contrary, this patent covers all methods, apparatus, and articles of manufacture fairly falling within the scope of the claims of this patent.

What is claimed is:

1. A method of measuring exposure to streaming media, the method comprising:
extracting a watermark from media obtained from a media provider;
generating metadata identifying the media based on the extracted watermark;
transcoding the media into a transport stream, the transport stream having a streaming format; and
embedding the metadata in a metadata channel of the transport stream.

2. The method as described in claim 1, further comprising transmitting the transport stream to a requesting device.

3. The method as described in claim 2, wherein the media is obtained from the media provider in response to a request from the requesting device.

4. The method as described in claim 1, wherein the media obtained from the media provider is live media.

5. The method as described in claim 1, wherein the media obtained from the media provider is stored media.

6. The method as described in claim 1, wherein the streaming format is a HyperText Transfer Protocol (HTTP) Live Streaming (HLS) format.

7. The method as described in claim 1, wherein the watermark is an audio watermark.

8. The method as described in claim 1, wherein the watermark is a video watermark.

9. The method as described in claim 1, wherein the metadata is formatted as an ID3 tag.

10. An apparatus to measure exposure to streaming media, the apparatus comprising:
a media identifier to generate media-identifying metadata based on a watermark extracted from the media;
a transcoder to transcode the media into a transport stream; and
a metadata embedder to embed the metadata in a metadata channel of the transport stream.

11. The apparatus as described in claim 10, further comprising a media transmitter to transmit the transport stream.

12. The apparatus as described in claim 10, wherein the transport stream is formatted in a streaming format.

13. The apparatus as described in claim 12, wherein the streaming format is a HyperText Transfer Protocol (HTTP) Live Streaming (HLS) format.

14. The apparatus as described in claim 10, wherein the metadata is formatted as an ID3 tag.

15. A tangible machine-readable storage medium comprising instructions which, when executed, cause a machine to at least:
extract a watermark from media obtained from a media provider;
generate metadata identifying the media based on the extracted watermark;
transcode the media into a transport stream, the transport stream having a streaming format; and
embed the metadata in a metadata channel of the transport stream.

16. The machine-readable medium as described in claim 15, further comprising instructions which, when executed, cause the machine to transmit the transport stream to a requesting device.

17. The machine-readable medium as described in claim 16, wherein the media is obtained from the media provider in response to a request from the requesting device.

18. The machine-readable medium as described in claim 15, wherein the streaming format is a HyperText Transfer Protocol (HTTP) Live Streaming (HLS) format.

19. The machine-readable medium as described in claim 15, wherein the watermark is an audio watermark.

20. The machine-readable medium as described in claim 15, wherein the metadata is formatted as an ID3 tag.
